(19) United States
(12) Patent Application Publication
(10) Pub. No.: US 2024/0177259 A1
(43) Pub. Date: May 30, 2024

(54) INFORMATION PROCESSING APPARATUS

(71) Applicant: TOYOTA JIDOSHA KABUSHIKI KAISHA, Toyota-shi Aichi-ken (JP)

(72) Inventor: Keizoh KAWAGUCHI, Okazaki-shi Aichiken (JP)

(73) Assignee: TOYOTA JIDOSHA KABUSHIKI KAISHA, Toyota-shi Aichi-ken (JP)

(21) Appl. No.: 18/512,736

(22) Filed: Nov. 17, 2023

(30) Foreign Application Priority Data
Nov. 24, 2022 (JP) 2022-187557

(51) Int. Cl. G06Q 50/47; G06Q 10/02

(52) U.S. Cl. CPC G06Q 50/47; G06Q 10/02

(57) ABSTRACT

An information processing apparatus, when the controller receives a first notification indicating that an equipment installed in a vehicle is in an inappropriate state that is not in a predetermined state from the vehicle shared by multiple users, reads borrowing information that includes a combination of information indicating a period of use of the vehicle and identification information of the user who uses the vehicle during the period of use. The information processing apparatus identifies one or more users as transmission destinations of a second notification indicating that the vehicle is in the inappropriate state based on reference time based on the first notification and the period of use. The information processing apparatus transmits the second notification to the user terminals used by the identified one or more users.

### CROSS REFERENCE TO THE RELATED APPLICATION

This application claims the benefit of Japanese Patent Application No. 2022-187557, filed on Nov. 24, 2022, which is hereby incorporated by reference.

### BACKGROUND

### Technical Field

This disclosure relates to information processing equipment that can communicate with shared vehicles.

### Description of the Related Art

In Japanese Patent Laid-Open No. 2006-235823, a device is proposed to notify vehicle users of forgotten operation of in-vehicle equipment.

### SUMMARY

The purpose of this disclosure is to provide a technique for notifying the user of a shared vehicle that the vehicle is in an inappropriate state.

An information processing apparatus according to the present disclosure comprises a controller comprising at least one processor configured to,
when the controller receives a first notification indicating that the equipment installed in a vehicle is in an inappropriate state that is not in a predetermined state from the vehicle shared by multiple users,
   read borrowing information that includes a combination of information indicating a period of use of the vehicle and identification information of the user who uses the vehicle during the period of use,
   identify one or more users as transmission destinations of a second notification indicating that the vehicle is in the inappropriate state based on the reference time based on the first notification and the period of use, and
   transmit the second notification to the user terminals used by the identified one or more users.

The present disclosure provides a technique for notifying the user of a shared vehicle that the vehicle is in an inappropriate state.

### BRIEF DESCRIPTION OF THE DRAWINGS

FIG. 1 indicates an example of the system configuration.

FIG. 2 is a schematic sequence diagram indicating an example of the process performed by the system.

FIG. 3 indicates an example of information stored in the server's storage device.

FIG. 4 is a process flow diagram indicating an example of the detailed process of S3 and S4 in FIG. 2

FIG. 5 illustrates the notification recipients.

FIG. 6 illustrates the notification recipients.

### DESCRIPTION OF THE EMBODIMENTS

An information processing apparatus comprises a controller comprising at least one processor configured to, when the controller receives a first notification indicating that the equipment installed in a vehicle is in an inappropriate state that is not in a predetermined state from the vehicle shared by multiple users, read borrowing information that includes a combination of information indicating a period of use of the vehicle and identification information of the user who uses the vehicle during the period of use, identify one or more users as transmission destinations of a second notification indicating that the vehicle is in the inappropriate state based on the reference time based on the first notification and the period of use, and transmit the second notification to the user terminals used by the identified one or more users.

The information processing device is a server device connected to a communication network, for example, and can communicate with a vehicle equipped with an in-vehicle communication device, for example. Vehicles that are shared by multiple users are, for example, shared or rented cars. The information processing apparatus shall store the period of use and the user who uses the vehicle during the period of use as borrowing information for such a vehicle. Borrowing information is, for example, reservation information that is registered before the vehicle is used. The borrowing information may include a history of operations, such as a log of locking and unlocking to the vehicle. The first notification is a notification of the status of the equipment installed in the vehicle, and is sent from the vehicle to the information processing apparatus at a predetermined timing. For example, the user can be notified that a door is open or closed, a lock is unlocked, a window is opened or closed, or a light is in an inappropriate state that is not in the predetermined state due to the user's forgetting to operate it or due to the operation of a third party. The second notification notifies the user of an inappropriate state from the information processing apparatus. The reference time may be, for example, the point in time when the information processing apparatus or vehicle detects the inappropriate state, or it may be the date and time when the information processing apparatus receives the first notification. In the case of a vehicle that is shared by multiple users, the information processor can use the first reference time and the borrowing information to appropriately select the destination of the second notification.

Specific embodiments of the present disclosure will be described below on the basis of the drawings. The dimensions, materials, shapes, and relative arrangement of the components, system configuration, data used for processing, etc. described in this embodiment are not intended to limit the technical scope of this disclosure to them alone, unless otherwise stated.

### 1st Embodiment

### (Configuration)

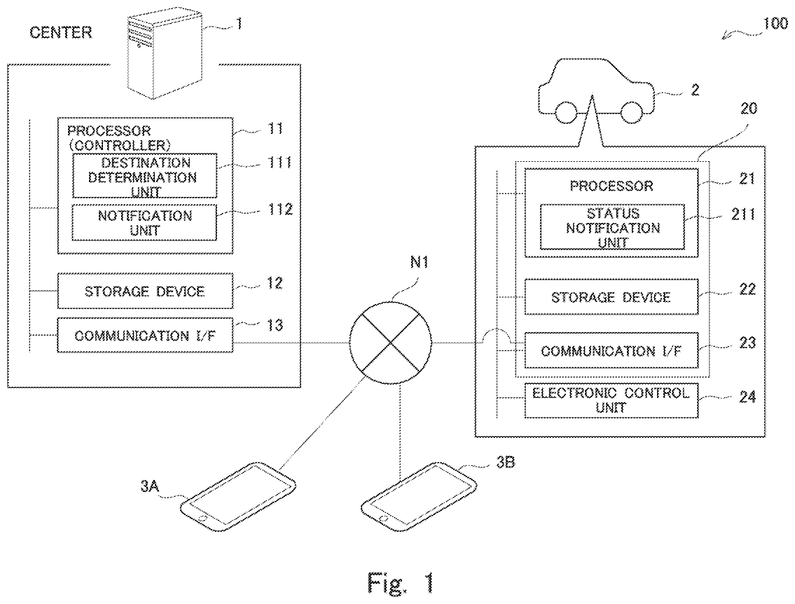

FIG. 1 is an example of the configuration of system for this embodiment is shown in Figure indicate. System 100 includes a server 1, a vehicle 2, a user terminal 3A, and a user terminal 3B (hereinafter referred to as user terminal 3) connected via network N1. Network N1 is a data communication network connected to the Internet, for example, and based on a predetermined protocol, the server 1 communicates with the vehicle 2 and user terminal 3, respectively. The server 1 may be a plurality of devices operating in coordination, or it may be a so-called cloud server. There may also be more than one vehicle 2. The vehicle 2 is a vehicle shared by multiple users, such as a shared or rented car, and one vehicle 2 is reserved and used by multiple users. For example, multiple users may belong to a predetermined group in a sharing or car rental service (hereinafter also referred to simply as “service”), such as family or corporate members.

Vehicle 2 also transmits the status of the equipment (devices) installed in vehicle 2 to server 1 after the vehicle stops. This notice shall also be referred to as the “first notification”. The state of the equipment is, for example, the opening and closing of doors and windows, locking and unlocking of doors, lighting of lights, etc. First notification may be made, among other things, when the equipment of vehicle 2 is in an inappropriate state that is not in the predetermined state. The first notification shall be made at a predetermined timing, such as after the ignition power is turned off, after detecting vibration, etc. of the parked vehicle 2, or periodically. The server 1 receives communication from vehicle 2 and notifies user terminal 3 of the status of vehicle 2 if it is in an inappropriate state. This Notice shall also be referred to as the “second notification”. The server 1 determines the destination of the second notification from the multiple user terminals 3 based on the period of use the shared vehicle 2 and the information of the users during that period.

The server 1 is an information processing apparatus that manages the vehicle 2. The server 1 is equipped with a processor 11, a storage device 12, and a communication interface (I/F) 13. The processor 11 is, for example, a CPU (Central Processing Unit), GPU (Graphics Processing Unit), ASIC (Application Specific Integrated Circuit), FPGA (Field Programmable Gate Array (FPGA), etc. The processor 11 is the control unit that executes the process described in this embodiment by reading and executing the program stored in the storage device 12. In the example in FIG. 1, the functional blocks are shown in the processor 11. In other words, the processor 11 functions as destination determination unit 111 and notification unit 112. The destination determination unit 111 receives communication regarding the status of vehicle 2 via communication I/F 13 and, if vehicle 2 is in an inappropriate state, selects the user terminal 3 to be the destination of the notification based on the period of use of vehicle 2 stored in storage device 12 and information on the users who will use the vehicle during that period. The notification unit 112 sends a notification that the vehicle 2 is in an inappropriate state to the selected user terminal 3 via the communication I/F 13.

The storage device 12 includes a main storage device such as RAM (Random Access Memory) and auxiliary storage devices such as ROM (Read Only Memory), HDD (Hard Disk Drive), SSD (Solid State Drive) or flash memory. Auxiliary storage devices may include removable media. Here, removable media are, for example, USB memory sticks, SD cards, or disk storage media such as CD-ROMs, DVD discs, or Blu-ray (registered trademark). The storage device 12 stores the program that executes the processing and the data used in the processing. The storage device 12 also stores borrowing information of the vehicle 2, user information registered for the service, and information sent and received in the embodiment. The borrowing information of vehicle 2 includes the date and time of use of vehicle 2 and the information of the user who uses the vehicle 2 on that date and time. For example, the borrowing information may be information to reserve the use of vehicle 2, and the date and time of use may include a start and end date. The borrowing information may also include a history of operations on the vehicle 2, such as locking and unlocking. The user information includes, for example, identification information of the user who uses the service and contact information such as the email address of said user. The user information may also include information indicating whether the user belongs to a group such as family members or corporate members.

The communication I/F 23 is a network interface controller for connecting the server 1 to network N1. The communication I/F 23 operates according to the communication standard of a wired LAN, for example, and connects the server 1 to the network N1.

The vehicle 2 is equipped with a processor 21, a storage device 22, a communication interface (I/F) 23, and an electronic control unit 24, and is connected to the server 1 via the communication I/F 23 and network N1. The processor 21, the storage device 22, and the communication I/F 23 may be components of a single in-vehicle device 20, or at least some of these components may be distributed and implemented in multiple in-vehicle devices, etc., rather than in a single module.

The processor 21 is, for example, a CPU, DSP (Digital Signal Processor), ASIC, FPGA, etc. The processor 21 executes the process described in this embodiment by reading and executing the program stored in storage device 22. In the example in FIG. 1, the functional blocks are indicated in processor 21. In other words, the processor 21 functions as the status notification unit 211. The status notification unit 211 obtains information indicating the status of the equipment of the vehicle 2 from the electronic control unit 24 and transmits it to the server 1 via the communication I/F 23.

The storage device 22 includes a main storage device such as RAM, and auxiliary storage devices such as ROM, HDD, SSD or flash memory. The auxiliary storage device may include removable media (portable recording media). Here, removable media are, for example, USB memory sticks, SD cards, or disk storage media such as CD-ROMs, DVD discs, or Blu-ray (registered trademark) discs. The storage device 22 stores programs that execute the implementation process and data used in the process.

The communication I/F 23 is an interface for connecting the vehicle 2 or the in-vehicle equipment provided by the vehicle 2 to network N1. The communication I/F 23 uses a predetermined wireless communication standard, such as 4G (4th Generation Mobile Communication System) or 5G (5th Generation Mobile Communication System), for example, to directly connect the vehicle 2 or in-vehicle device to the network N1 may be connected to the network N1.

The electronic control unit 24 is an ECU that detects and electronically controls the status of, for example, the doors, windows, and lights of the vehicle 2. The vehicle 2 will be equipped with a plurality of the electronic control units 24. For example, the door status may indicate that the door is open, closed or unlocked. The window status may indicate whether the window is open or closed. The status of lights may indicate whether headlamps, fog lamps, small lamps, hazard lamps, blinkers, room lamps, etc. are on, blinking or off.

The above configurations are connected via signal lines and communicate according to in-vehicle communication standards such as CAN (Controller Area Network) and LIN (Local Interconnect Network), for example.

### (Processing)

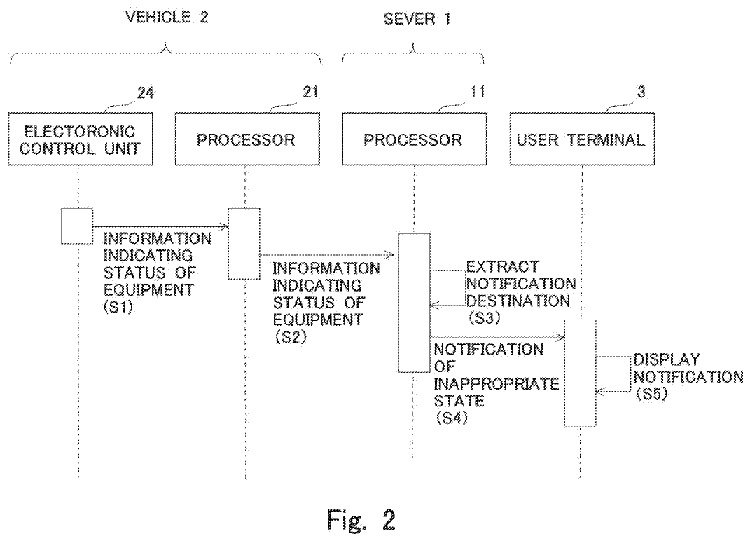

FIG. 2 is a schematic sequence diagram indicating an example of the process performed by the system 100. This process shall be performed, for example, after the ignition power of vehicle 2 is turned off, after vibrations or other events are detected in the parked vehicle 2, or periodically. When vehicle 2 is parked, processor 21, which can communicate via network N1, may be activated when a monitoring processor with relatively low power consumption detects the inappropriate state. The electronic control unit 24 of vehicle 2 sends installed in vehicle 2 (FIG. 2: S1). In this step, one or more electronic control devices 24 transmits, for example, information indicating the opening/closing or locking of a door, information indicating the opening/closing of a window, or information indicating the turning on, blinking, or turning off of a headlamp, fog lamp, small lamp, hazard lamp, blinker, room lamp, or the like to the processor 21.

When the status notification unit 211 of the processor 21 obtains the notification from the electronic control unit 24, it sends information indicating the status of the equipment in vehicle 2 to server 1 via communication I/F 23 (FIG. 2: S2). The notification sent in this step (the first notification) may simply be information about the status of the equipment, or it may be information that the equipment is in an inappropriate state that is not in the predetermined state. In other words, the status notification unit 211 may determine whether the equipment is in an inappropriate state and notify the server 1 if it is determined to be in an inappropriate state. Inappropriate conditions include, for example, when the doors of the vehicle 2 remain open for more than a predetermined time, when the door locks remain unlocked for more than a predetermined time, when the windows remain open for more than a predetermined time, or when the lights are not turned off.

When the server 1 obtains a notification from the vehicle 2 indicating that it is in an inappropriate state, it further notifies the user terminal 3. Based on the information transmitted in S2, the server 1 may determine whether the vehicle 2 is in an inappropriate state. The destination determination unit 111 of server 1 extracts a destination for notification that the vehicle 2 is improperly equipped (FIG. 2: S3). In this step, the destination determination unit 111 determines the target users to be notified of the inappropriate status from among the multiple users of the service. In other words, the destination determination unit 111 reads the borrowing information of the vehicle 2 and extracts the target person at the base time, for example, at the time of processing at the server 1 (in other words, at the time when the server 1 receives the notification of the inappropriate status from the vehicle 2). If the notification of an inappropriate state sent from the vehicle 2 to the server 1 includes the date and time when the inappropriate state was detected in the vehicle 2, the date and time may be used as the reference time. However, since there may be a delay between the detection of the inappropriate state in the vehicle 2 and the notification to the server 1, the server 1 may determine the subsequent notification destination based on the date and time when server 1 receives the notification of the inappropriate state. For example, a person who is using vehicle 2 at the reference time is preferentially selected as the target person. If there is no applicable person, a person who has been using the vehicle 2 during the predetermined time before the reference time, or a person who is scheduled to start using the vehicle 2 during the predetermined time after the reference time, etc. may be considered as a target person.

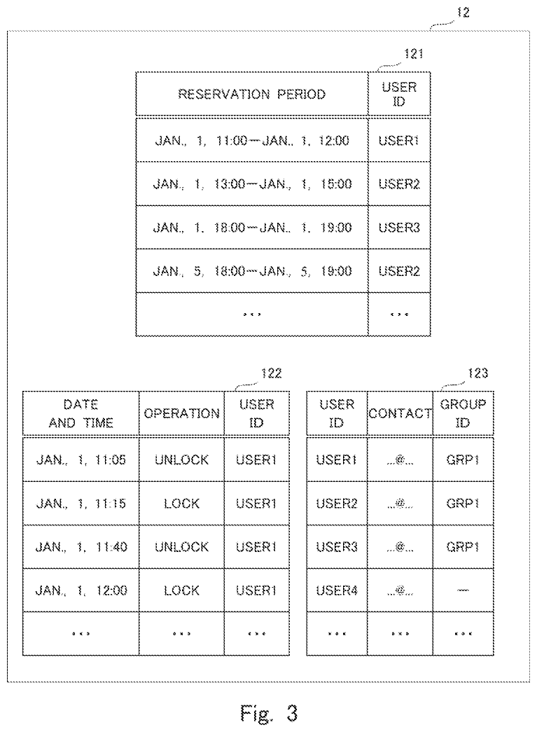

FIG. 3 indicates an example of information stored in storage device 12 of the server 1. In the example in FIG. 3, the storage device 12 stores reservation information 121 for registering the period of time reserved by the user before using the vehicle 2, historical information 122 for recording the operation history of the vehicle 2, and user information 123 for registering the user who uses the service. Each of the records held in the reservation information 121 and Historical Information 122 is an example of borrowing information. The historical information 122 does not have to be stored. The data structure of the tables shown in FIG. 3 is an example, and information may be normalized and stored separately in multiple tables or denormalized and stored together in a single table, as appropriate.

The table of reservation information 121 includes the attributes of “reservation period” and “user ID”. In the “Reservation Period” field, the period of time during which the user wishes to use the vehicle 2 is registered. The period is represented by a date and time that represents the beginning and end of the period. The information registered in the Reserved Period field is an example of the “period of use” during which the user will use the vehicle 2. In the “User ID” field, identification information is registered to uniquely identify the user who made a reservation for the corresponding period. The above information is created for one vehicle 2. A record is also registered in such reservation information 121 when a user reserves the use of vehicle 2 by operating, for example, the user terminal 3.

The table of historical information 122 includes the attributes of “Date and Time”, “Operation” and “User ID”. The “Date and Time” field registers the date and time the user operated the vehicle 2. The “Operation” field registers the type of operation, including unlocking and locking. In the “User ID” field, identification information to uniquely identify the user who operated the system is registered. In such historical information 122, for example, a record is created each time the user operates the vehicle 2, with notification from the vehicle 2. The period of time defined by the information registered in the Date and Time fields of a series of records indicating operations by the same user is an example of the “period of use” during which the user uses the vehicle 2.

The User Information 123 table contains the attributes “User ID”, “Contact” and “Group ID”. In the “User ID” field, identification information to uniquely identify the user is registered. In the “Contact” field, information indicating the user's contact information, such as an e-mail address for example, is registered. The contact information may be, for example, identification information for sending a message to the user terminal 3 when the user installs a certain application software on the user terminal 3. In the “Group ID” field, the identification information to identify the group is registered when the corresponding user belongs to a group such as a family member or a corporate member. In such user information 123, a record is registered when the user starts using the service.

In S3 of FIG. 2, the subject is determined based on the relationship between the date and time of the borrowing information and the reference time mentioned above, and the contact information of the subject is extracted. The details of the process for extracting notification destinations are described below.

The notification unit 112 of the server 1 sends a notification of the inappropriate state to the extracted notification recipients (FIG. 2: S4). In this step, the notification unit 112 sends a notification of the inappropriate state via the communication I/F 13 to the notification destination extracted in S3. On the other hand, if the user terminal 3 to which the notification is sent receives a notification via network N1 that an inappropriate state has occurred, it causes the contents of the notification to be output to a display or the like (FIG. 2: S5). In this way, the user of the user terminal 3 who receives the notification will know that an inappropriate state has occurred in the vehicle 2.

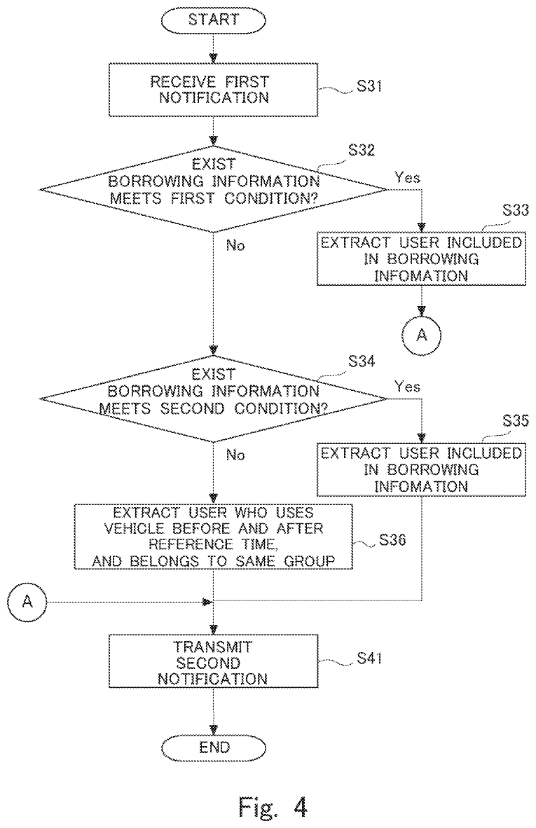

FIG. 4 is a process flow diagram indicating an example of the detailed process of S3 and S4 indicated in FIG. 2 The destination determination unit 111 in the server 1 receives a notification indicating the status of the equipment installed in the vehicle 2 (first notification) (FIG. 4: S31). The subsequent process is performed when the notification indicates that the condition is inappropriate. The destination determination unit 111 determines whether there is borrowing information that meets the first condition (FIG. 4: S32). The first condition is, for example, that the reference time includes the reference time within the reservation period of the reservation information 121 shown in FIG. 3, or within the first predetermined time from the reservation period, using the point in time when the server 1 receives the notification as the reference time. If it is determined that borrowing information satisfying the first condition exists (S32: YES), the destination determination unit 111 extracts the user included in the borrowing information. In other words, when the server 1 receives a notification of an inappropriate state from the vehicle 2, the user who is using the vehicle 2, the user immediately after using the vehicle 2, or the user immediately before using the vehicle 2 is identified as the transmission destination.

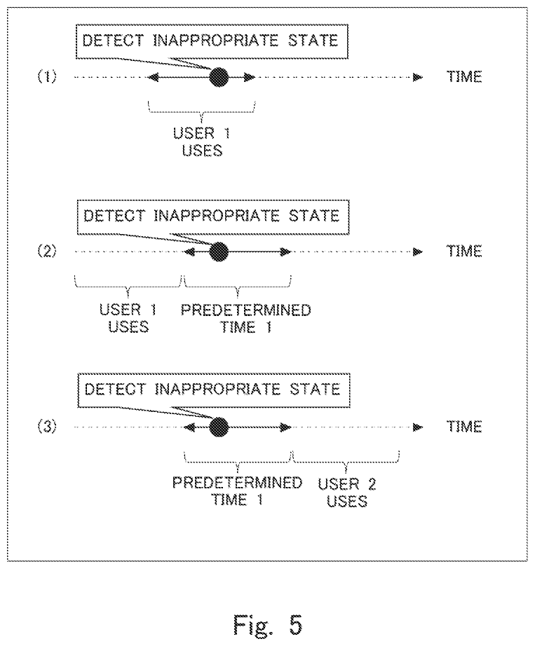

FIG. 5 illustrates the notification recipients. In FIG. 5, the dashed arrows represent the passage of time, and the black circle shall represent the point in time when server 1 received the notification of the inappropriate state from vehicle 2. The top row (1) of FIG. 5 indicates the case where there is a user in use at the reference time. The solid arrows represent the reservation period for the user 1. For example, if the server 1 receives a notification of an inappropriate state from the vehicle 2 while user 1 is using the vehicle 2, the user 1 who is using the vehicle 2 is the recipient of the notification. In other words, if there is a reservation that includes a reference time in the reservation period in the record registered in the reservation information 121 shown in FIG. 3, the contact information of the user who made the reservation is extracted as the notification destination. The second row (2) from the top in FIG. 5 indicates the case where there is a user who has been using the vehicle 2 within a predetermined time from the reference time. The situation in (2) can occur when the user uses the vehicle 2 beyond the end of the reservation period, when communication from the vehicle 2 to the server 1 is delayed, or when a third party operates the vehicle 2. The solid arrow represents the first predetermined time (predetermined time 1). For example, if server 1 receives a notification of an inappropriate state from vehicle 2 within the first predetermined time from the user 1 reservation period, the user 1 who was using the vehicle immediately before is the recipient of the notification. In other words, if a reservation exists in the record registered in the reservation information 121 shown in FIG. 3 whose end of the reservation period is within the first predetermined time from the reference time, the contact information of the user who made the reservation is extracted as the notification destination. The first predetermined time shall be set appropriately, for example, 5 or 10 minutes. If the storage device 12 of the server 1 stores the historical information 122 shown in FIG. 3, the user who performed some operation within the first predetermined time from the reference time may be extracted. The third row (3) from the top in FIG. 5 indicates the case where a user is scheduled to start using the system within a predetermined time from the reference time. The situation in (3) can occur when the user starts using the vehicle 2 before the beginning of the reservation period or when a third party operates the vehicle 2. For example, if there is a reservation for which the reservation period begins within the first predetermined time after the server 1 receives the notification of the inappropriate state from the vehicle 2, the user 2 who has reserved the vehicle 2 is the recipient of the notification. In other words, if a reservation exists in the record registered in the reservation information 121 shown in FIG. 3, whose reservation period begins within the first predetermined time from the reference time, the contact information of the user who made the reservation is extracted as the notification destination. The first predetermined time may be of different lengths before and after the reference time. In S32 and S33 of FIG. 4, for example, the user's contact information corresponding to (1) through (3) in FIG. 5 is extracted.

On the other hand, if it is determined in S32 that there is no borrowing information that meets the first condition (S32: NO), the destination determination unit 111 determines whether there is borrowing information that meets the second condition (FIG. 4: S34). The second condition is that the time between the two periods of use before and after the reference time is within a second predetermined time longer than the first predetermined time.

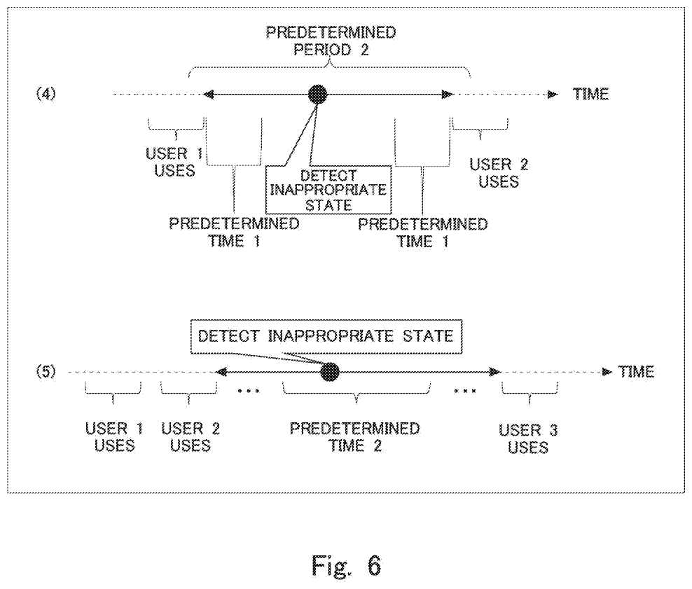

FIG. 6 also illustrates the recipients of the notifications. In FIG. 6, the dashed arrows also represent the passage of time, and the black circle shall represent the point in time when the server 1 received the notification of the inappropriate state from the vehicle 2. In FIG. 6, the solid arrows represent the intervals of use before and after the reference time. The upper row (4) indicates the case where there is no borrowing information that satisfies the first condition described above and there are two borrowing information whose interval of use before and after the reference time is less than the second predetermined time (predetermined time 2), which is longer than the first predetermined time described above. Specifically, the second predetermined time is at least twice as long as the first predetermined time. That is, among the records registered in the reservation information 121 shown in FIG. 3, if there exists a reservation for which the interval between the end of the reservation period before the first predetermined time and closest to the reference time and the beginning of the reservation period after the second predetermined time and closest to the reference time is less than the second predetermined time, the contact information of the user who made the reservation before or after the reference time is extracted as the notification address. The second predetermined time shall also be set appropriately, for example, 12 hours, 24 hours, etc. In S34 and S35 of FIG. 4, for example, the user's contact information corresponding to (4) in FIG. 5 is extracted. The second condition in S34 of FIG. 4 is not limited to the one described above, and may be, for example, that the interval between each of the two reservation periods for the previous and following user and the reference time is within a time longer than the first predetermined time.

On the other hand, when it is determined in S34 that the borrowing information corresponding to the second condition does not exist (S34: NO), the destination determination unit 111 extracts, for example, a user who uses the vehicle 2 before the reference time, a user who intends to use the vehicle 2 after the reference time, and a user who belongs to the same group as the user (FIG. 4: S36). In other words, borrowing information that stores the usage period before the base time and closest to the base time or after the base time and closest to the base time is extracted, and the user stored in the extracted borrowing information and the user associated with that user via group ID are identified as the transmission destination.

The bottom row (5) of FIG. 6 indicates the case where there is no borrowing information that satisfies the first and second conditions described above. For example, if the reservation period of user 2 before the reference time and the reservation period of user 3 after the reference time are registered with an interval of at least the second predetermined time, for example, the user 2 who used the system immediately before the reference time is the target of notification. In other words, among the records registered in the reservation information 121 shown in FIG. 3, the contact of the user whose end of the reservation period is closest to the reference time is extracted as the notification destination. Furthermore, if there are users who belong to the same group as the extracted user, users who belong to the same group may be extracted. In the case of the bottom row (5) of FIG. 6, if User 1, User 2 and User 3 are family or corporate members tied as the same group, then User 1 and User 3 shall also be extracted. In other words, in the case of FIG. 6, when server 1 receives a notification of an inappropriate state, the appropriate user who should be notified of this is not expected to be present around vehicle 2, so the number of notification destinations is increased. Since some time has passed since the previous use, even if it is the closest to the reference time, the user who used the product immediately before the reference time may not be held responsible for the inappropriate state. For example, the vehicle 2 could have been put into an improper state by a third party's operation. Therefore, it may be possible to extract not the user who was using immediately before the reference time, but the user who is after the reference time and has the closest use reservation to the reference time. For users belonging to the same group, only users who have a history of using vehicle 2 in the past may be extracted. For users belonging to the same group, a third predetermined time longer than the second predetermined time may be set in advance, and users belonging to the same group as those who use or have used the vehicle 2 within the third predetermined time before and after the reference time may be extracted.

After S33, S35 and S36 in FIG. 4, the notification unit 112 sends a notification of the inappropriate status to the extracted notification recipient (FIG. 4: S41). This step is identical to S4 in FIG. 2.

### Effects

According to this system, the user of the user terminal 3 who receives the notification will know that an inappropriate state has occurred in the vehicle 2. Thus, if the user of the terminal 3 is using the vehicle 2 or after using the vehicle 2, the user can return to vehicle 2 to change the equipment of the vehicle 2 to a predetermined state. In addition, the user of terminal 3 can know the condition of vehicle 2 in advance, before the vehicle 2 is used. According to S36 in FIG. 4, multiple users belonging to the same group are also notified, and it can be expected that one of the convenient users will resolve the inappropriate state.

### OTHER EMBODIMENTS

The above embodiments are examples only, and the present disclosure may be modified and implemented as appropriate without departing from the gist thereof. The processes and components described in this disclosure may be freely combined and implemented as long as there is no technical contradiction.

If, after notifying multiple user terminal 3s of an inappropriate status, the inappropriate status is resolved by the operation of any of the users, the user terminal 3 that notified the user of the inappropriate status may be notified that the inappropriate status has been resolved.

The process described as being performed by one device may be shared and executed by multiple devices. Alternatively, the processes described as being performed by different devices may be performed by one device. In a computer system, it is possible to flexibly change what hardware configuration (server configuration) is used to realize each function.

This disclosure can also be realized by supplying a computer program implementing the functions described in the above embodiments to a computer, and having one or more processors of said computer read and execute the program. Such computer programs may be provided to a computer by a non-transitory computer-readable storage medium that can be connected to the computer's system bus, or may be provided to a computer over a network. Non-transitory computer-readable storage media include, for example, any type of disk, such as magnetic disks (floppy (registered trademark) disks, hard disk drives (HDD), etc.), optical disks (CD-ROM, DVD disks, Blu-ray disks, etc.), read-only memory (ROM), random access memory (RAM), EPROM, EEPROM, magnetic cards, flash memory, or any type of media suitable for storing electronic instructions, such as optical cards.

What is claimed is:

1. An information processing apparatus comprising a controller comprising at least one processor configured to,
when the controller receives a first notification indicating that an equipment installed in a vehicle is in an inappropriate state that is not in a predetermined state from the vehicle shared by multiple users,
read borrowing information that includes a combination of information indicating a period of use of the vehicle and identification information of the user who uses the vehicle during the period of use,
identify one or more users as transmission destinations of a second notification indicating that the vehicle is in the inappropriate state based on reference time based on the first notification and the period of use, and
transmit the second notification to user terminals used by the identified one or more users.

2. The information processing apparatus according to claim 1, wherein
the controller identifies the user included in the borrowing information that meets first condition that there exists the borrowing information where the reference time is included in the period of use or first predetermined time from the period of use, as the transmission destination.

3. The information processing apparatus according to claim 2, wherein,
when there is no borrowing information that satisfies the first condition, the controller identifies the user of first borrowing information and the user of second borrowing information as the transmission destinations if time between end of the period of use of the first borrowing information including the period of use closest to the reference time before the reference time and start of the period of use of the second borrowing information including the period of use closest to the reference time after the reference time satisfies second condition that is within a second predetermined time longer than the first predetermined time.

4. The information processing apparatus according to claim 3, wherein
the user is associated with other users via group information representing family members or corporate members, and
if there is no borrowing information that satisfies the first and second conditions, the controller extracts the borrowing information that includes the period of use before the reference time and closest to the reference time, or after the reference time and closest to the reference time, and
identify the user stored in the extracted borrowing information and the user associated with the user via the group information as the transmission destination.

5. The information processing apparatus according to claim 1, wherein
the reference time is date and time when the information processing apparatus received the first notification from the vehicle.
